(19) United States
(12) Patent Application Publication
(10) Pub. No.: US 2017/0371593 A1
(43) Pub. Date: Dec. 28, 2017

(54) SELECTIVE FLASH MEMORY COMPRESSION/DECOMPRESSION USING A STORAGE USAGE COLLAR

(71) Applicant: QUALCOMM INCORPORATED, SAN DIEGO, CA (US)

(72) Inventors: YANRU LI, SAN DIEGO, CA (US); DEXTER CHUN, SAN DIEGO, CA (US)

(21) Appl. No.: 15/191,399

(22) Filed: Jun. 23, 2016

(51) Int. Cl. G06F 3/06; G06F 17/30

(52) U.S. Cl. CPC G06F 3/0661; G06F 17/30153; G06F 3/0608; G06F 3/0679

(57) ABSTRACT

Systems, methods, and computer programs are disclosed for selectively compressing/decompressing flash storage data. An embodiment of a system comprises a compression/decompression component, a flash memory device, a flash controller in communication with the flash memory device, and a storage driver in communication with the compression/decompression component and the flash controller. The storage driver is configured to selectively control compression and decompression of data stored in the flash memory device, via the compression/decompression component, according to a storage usage collar comprising an upper usage threshold and a lower usage threshold.

### DESCRIPTION OF THE RELATED ART

Non-volatile storage, such as flash storage, is incorporated in various types of computing devices, including portable computing devices (e.g., cellular telephones, smart phones, tablet computers, portable digital assistants (PDAs), portable game consoles, wearable devices, and other battery-powered devices). To address user demands, the capacity of NAND flash storage in portable computing devices continues to increase. However, larger NAND flash storage significantly increases the cost of portable computing devices. A common solution to cost pressure is to implement filesystem compression, which keeps user data as compact as possible. While compression solutions can temporarily extend the limited capacity of NAND flash storage, the process of compressing/decompressing the data negatively impacts performance of the portable computing device and increases power consumption, which undesirably reduces battery life.

Accordingly, there is a need for improved systems and methods for selectively enabling compression/decompression of flash storage data to increase storage capacity without negatively impacting device performance and user experience.

### SUMMARY OF THE DISCLOSURE

Systems, methods, and computer programs are disclosed for selectively compressing/decompressing flash storage data. An embodiment of a system comprises a compression/decompression component, a flash memory device, a flash controller in communication with the flash memory device, and a storage driver in communication with the compression/decompression component and the flash controller. The storage driver is configured to selectively control compression and decompression of data stored in the flash memory device, via the compression/decompression component, according to a storage usage collar comprising an upper usage threshold and a lower usage threshold.

Another embodiment is a method for selectively compressing/decompressing flash storage data. The method comprises defining a storage usage collar associated with a flash memory device. The storage usage collar comprises an upper usage threshold and a lower usage threshold. If the storage usage exceeds the upper usage threshold of the storage usage collar, an amount of free space on the flash memory device is increased by: reading a first portion of uncompressed data from the flash memory device, compressing the first portion of uncompressed data to generate a first portion of compressed data, and rewriting the first portion of compressed data to the flash memory device. If the storage usage falls below the lower usage threshold of the storage usage collar, the amount of free space on the flash memory device is decreased by: reading a second portion of compressed data from the flash memory device, uncompressing the second portion of compressed data to generate a second portion of uncompressed data, and rewriting the second portion of uncompressed data to the flash memory device.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same Figure. Letter character designations for reference numerals may be omitted when it is intended that a reference numeral to encompass all parts having the same reference numeral in all Figures.

FIG. 1 is a block diagram of an embodiment of a system for providing selective flash memory compression/decompression using a storage usage collar.

FIG. 2 is a block diagram illustrating an exemplary embodiment of a storage usage collar for controlling compression/decompression of data in the flash memory device.

FIG. 3a illustrates an initial control mode of the system in FIG. 1 in which data is written to the flash memory device without compression when current storage usage is below the storage usage collar.

FIG. 3b illustrates a second control mode of the system in FIG. 1 in which a background scrubbing process is initiated when current storage usage exceeds the lower threshold of the storage usage collar.

FIG. 3c illustrates a third control mode of the system in FIG. 1 in which data is written to the flash memory device with compression when the current storage usage exceeds the upper threshold of the storage usage collar.

FIG. 3d illustrates a fourth control mode of the system in FIG. 1 in which previously compressed data is rewritten to the flash memory device as uncompressed data when the current storage usage falls below the lower threshold of the storage usage collar.

FIG. 4 is a flowchart illustrating an embodiment of a method for providing selective flash memory compression/decompression using the storage usage collar.

FIG. 5 is a data diagram illustrating exemplary blocks of compressed and uncompressed data in the flash memory device.

FIG. 6 is a block diagram of an embodiment of a portable computing device for incorporating the system of FIG. 1.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

The term “content” may also include files having executable content, such as: object code, scripts, byte code, markup language files, and patches. In addition, “content” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers.

In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone”, “wireless communication device,” and “wireless handset” are used interchangeably. With the advent of third generation (“3G”) wireless technology and four generation (“4G”), greater bandwidth availability has enabled more portable computing devices with a greater variety of wireless capabilities. Therefore, a portable computing device may include a cellular telephone, a pager, a PDA, a smartphone, a navigation device, or a hand-held computer with a wireless connection or link.

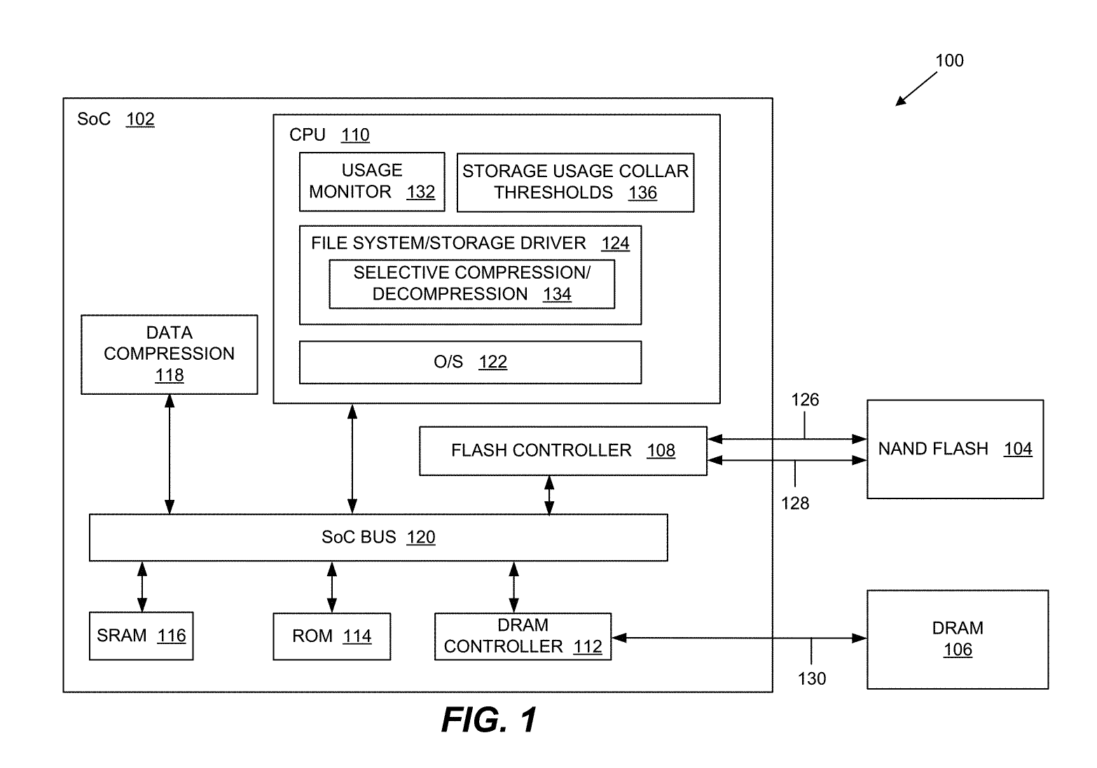

FIG. 1 illustrates a system 100 for selectively compressing/decompressing flash storage data using a storage usage collar. The system 100 comprises a system on chip (SoC) 102 electrically coupled to a flash memory device (e.g., NAND flash 104) and a volatile random access memory (VRAM), such as, a dynamic random access memory (DRAM) 106. The SoC 102 may be electrically coupled to the NAND flash 104 via a control bus 126 and a data bus 128. The SoC 102 may be electrically coupled to the DRAM 106 via a bus 130. The system 100 may be implemented in any computing device, including a personal computer, a workstation, a server, a portable computing device (PCD), such as a cellular telephone, a smartphone, a portable digital assistant (PDA), a portable game console, a navigation device, a tablet computer, a wearable device, such as a sports watch, a fitness tracking device, etc., or other battery-powered, web-enabled devices.

The SoC 102 comprises various on-chip components, including a central processing unit (CPU) 110 that executes an operating system (O/S) 122, a DRAM controller 112, static random access memory (SRAM) 116, read only memory (ROM) 114, a data compression component 118, and a flash controller 108 interconnected via a SoC bus 120. The SoC 102 may include one or more memory clients that request memory resources from the DRAM 106 and the NAND flash 104. The memory clients may comprise one or more processing units (e.g., central processing unit (CPU) 110, a graphics processing unit (GPU), a digital signal processor (DSP), etc.), a video encoder, or other clients requesting read/write access to the NAND flash 104 and the DRAM 106.

In the embodiment illustrated in FIG. 1, the NAND flash 104 is separate from the SoC 102, although in other embodiments the NAND flash 104 may be physically attached or stacked onto the SoC die and reside in the same physical package as the SoC die. As known in the art, the NAND flash 104 may include a controller and a main array for storing physical pages. The CPU 110 residing on the SoC 102 reads and/or writes data in units of logical pages to the NAND flash 104 via the flash controller 108. The data is stored and retrieved from the physical pages of the main array, along with error correction bit(s) generated/checked by an error correcting code (ECC) module either located within the flash device 104 or in the SoC 102.

As further illustrated in FIG. 1, software running on CPU 110 comprises various components for selectively enabling compression/decompression of the data stored in the NAND flash 104. It should be appreciated that selective flash memory compression/decompression provides the ability to increase the storage capacity of the NAND flash 104 without negatively impacting device performance and user experience. The CPU 110 is operatively coupled to the data compression component 118. In this manner, the software on CPU 110 controls whether data written to the NAND flash is to be compressed by the data compression component 118 or remain uncompressed. In an embodiment, the data compression component 118 comprises a separate hardware unit for executing the data compression and decompression. In another embodiment, the CPU 110 may execute the data compression and decompression.

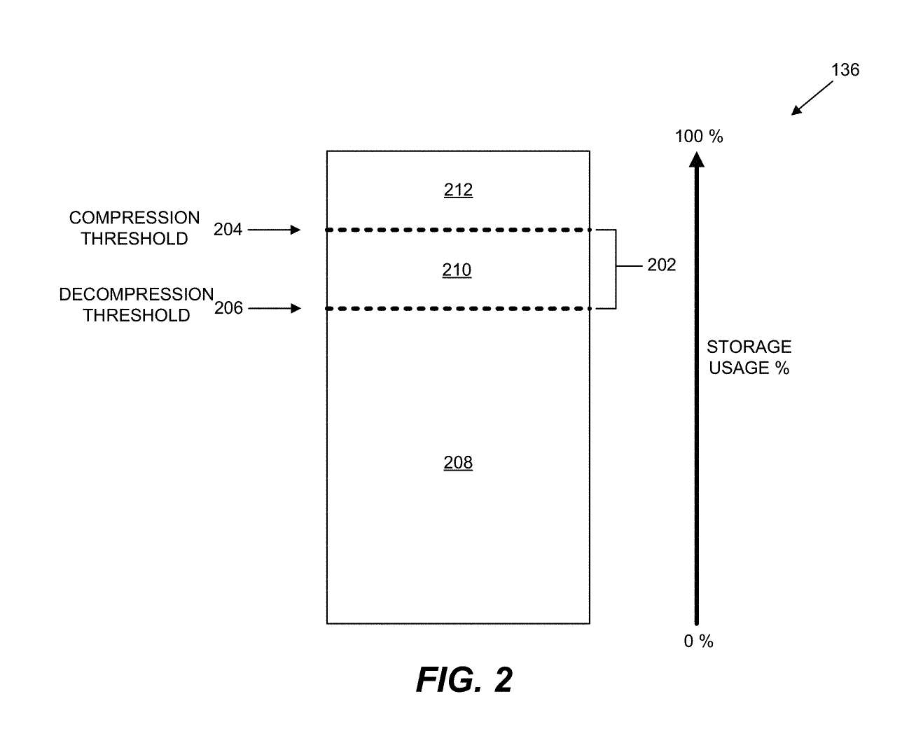

In the embodiment of FIG. 1, the CPU 110 provides selective flash memory compression/decompression via a storage usage monitor 132, a selective compression/decompression component 134, a storage usage collar 136, and a file system/storage driver 124. The storage usage collar 136 defines a lower usage threshold and an upper usage threshold associated with the capacity of the NAND flash 104. FIG. 2 illustrates an exemplary embodiment of the storage usage collar 136. The storage usage of the NAND flash 104 may be represented as a percentage along the y-axis from zero to full capacity (100%). A lower usage threshold 206 and an upper usage threshold 204 define a collar 202. The percentage values for the lower and upper usage thresholds 206 and 204 may be predefined, calculated, or programmed. It should be appreciated that the threshold values 206 and 204 are determined to provide an optimal window for extending the storage capacity of the NAND flash 104 (by writing compressed data) while minimizing power consumption and latency due to overuse of data compression. As described below in more detail, the file system/storage driver 124 running on CPU 110 selectively controls compression and decompression in such a way to generally maintain the storage capacity within the collar 202.

The usage monitor 132 comprises the logic for monitoring the storage capacity of the NAND flash 104 during operation of the system 100. The usage monitor 132 may be either a low priority task running on the OS 122 or a HW block with the monitoring functionality. The usage monitor 132 compares a current storage usage percentage against the lower usage threshold 206 and the upper usage threshold 204. Based on the periodic comparison, the usage monitor 132 keeps track of when the current storage capacity of the NAND flash 104 is within range 208 (i.e., below the lower usage threshold 206), within range 210 (i.e., the collar 202 between the lower usage threshold 206 and the upper usage threshold 204), or within range 212 (i.e., above the upper usage threshold 204). In this regard, the selective compression/decompression component 134 may select various control modes depending on the current storage usage determined by the usage monitor 132.

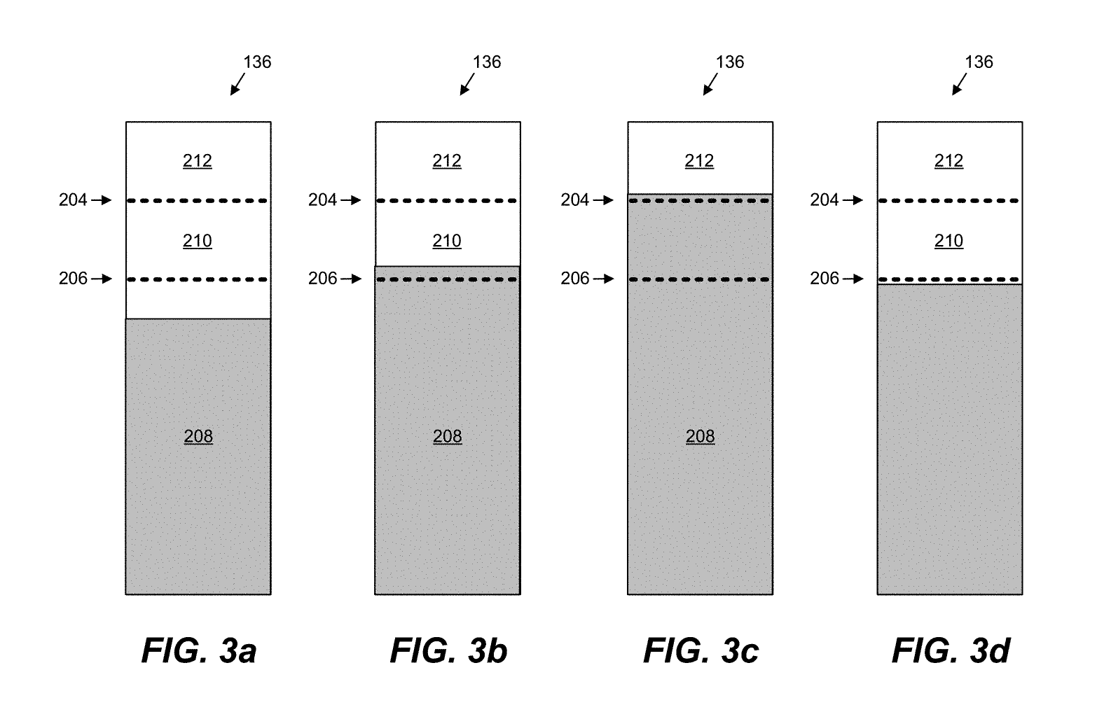

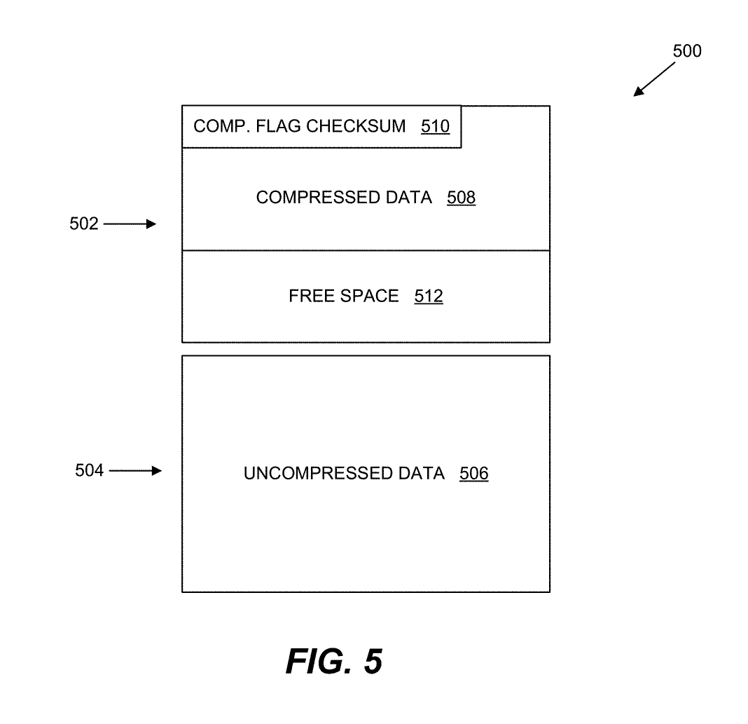

FIGS. 3a-3d illustrate four exemplary control modes. FIG. 3a illustrates an initial control mode of the system 100 that is active when the current storage usage is initially below the lower usage threshold 206. In the initial control mode, the file system/storage driver 124 may initially write data to the NAND flash 104 without compression to avoid latency and power consumption associated with performing the compression algorithms. As uncompressed data is written to the NAND flash 104, the storage usage may exceed the lower usage threshold 206 (FIG. 3b). When the lower usage threshold 206 is initially exceeded, the file system/storage driver 124 may initiate a background (i.e., low priority) scrubbing process to be carried out by the selective compression /decompression 134. In one embodiment, the scrubbing process piecewise traverses the nodes in the NAND file system directory to determine files that will be a candidate for compression. A flag is introduced to the file system mechanism to indicate whether a file has already been stored in a compressed format. The scrubbing process may determine candidate files for compression based on, for example, a file type, a file “modified date/time”, a file size, etc. For example, certain file types may be specified as “compressible” while other file types may be specified as “non-compressible”. The “modified date/time” may indicate files that are not in use or have not been recently accessed, which may be candidates for compression. Furthermore, files with a large size may give more benefit with compression. In another embodiment, the scrubbing process piecewise traverses the block in the storage. A header may be used for the data that is written to a block in a compressed format. An exemplary header format (FIG. 5) is described below in more detail.

As illustrated in FIG. 3c, as files continue to be written to NAND flash 104 without compression, the current storage usage may exceed the upper usage threshold 204. When the current storage usage exceeds the upper usage threshold 204, the file system/flash driver 124 may determine that the amount of free space on the NAND flash 104 should be increased, so that the storage usage is maintained in the collar 202. To increase the amount of free space, the filesystem/flash driver 124 may invoke the selective compression/decompression component 134 to select one or more files identified as compression candidates by the background scrubbing process. The uncompressed data in the candidate file(s) is read from the NAND flash 104, compressed by the data compression component 118, and rewritten to the NAND flash 104 to generate free space.

As illustrated in FIG. 3d, if the current storage usage falls below the lower usage threshold 206 (e.g., as a result of files being deleted), the file system/flash driver 124 may determine that the amount of free space on the NAND flash 104 may be decreased. To decrease the amount of free space, the file system/flash driver 124 may invoke the selective compression/decompression component 134 to select one or more compressed files to be uncompressed. The compressed data is read from the NAND flash 104, uncompressed by the data compression component 118, and rewritten to the NAND flash. It should be appreciated that the selection of file(s) for decompression may take into consideration a “modified date/time” and a file size to favor the more frequent used file to be uncompressed.

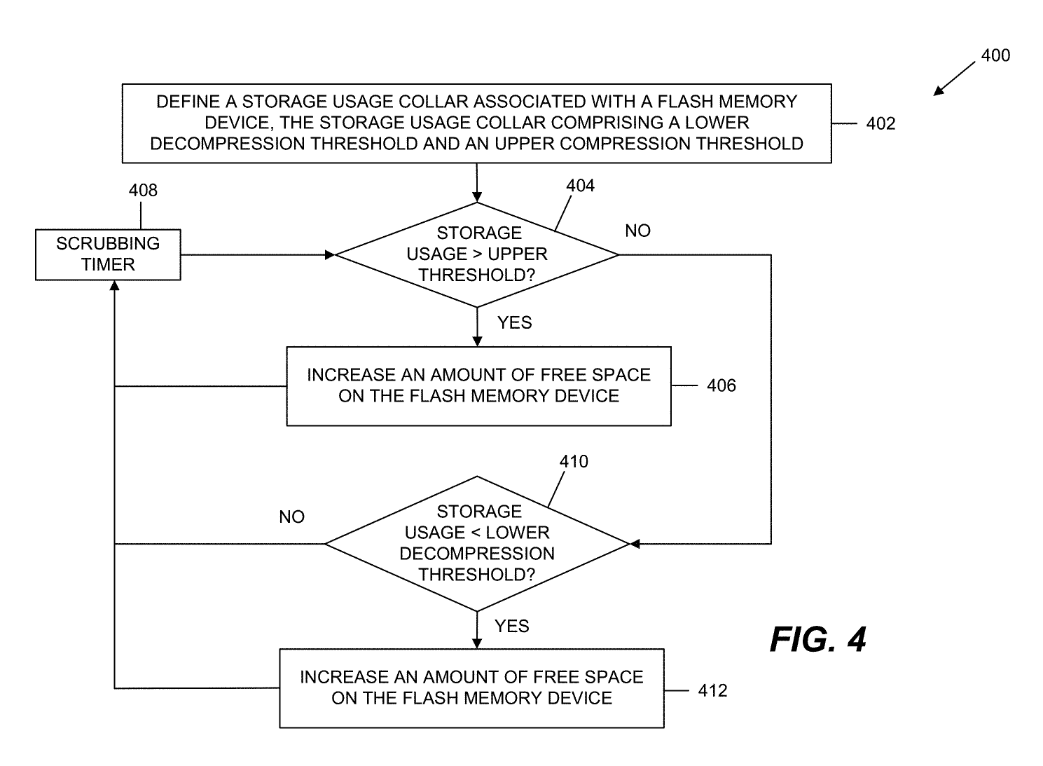

FIG. 4 is a flowchart illustrating an embodiment of a method 400 for providing selective flash memory compression/decompression using the storage usage collar 136. At block 402, a storage usage collar 136 associated with the file system/storage driver is determined. The values for the lower usage threshold 206 and the upper usage threshold 204 may be predetermined and stored in memory either in the flash controller 108 or otherwise. It should be appreciated that these values may also be calculated during operation of the system 100 based on varying conditions, use cases, etc. The lower usage threshold 206 and/or the upper usage threshold 204 may be individually or collectively adjusted to manage the inherent tradeoffs between available storage capacity, compression and decompression latency, and user experience.

The usage monitor 132 periodically checks the storage usage in the NAND flash 104 and compares it against the lower usage threshold 206 and the upper usage threshold 204. If the current storage usage exceeds the upper usage threshold 204 (decision block 404), the flash controller 108 increases an amount of free space on the NAND flash 104 (block 406). The file system/storage driver 124 may control the flash controller 108 to read a first portion of uncompressed data stored in the NAND flash 104. The first portion of uncompressed data may be compressed by the data compression component 118 to generate a first portion of compressed data. The first portion of compressed data is rewritten to NAND flash 104. A timer (block 408) may be used to periodically check the storage usage and return flow to decision block 404.

Referring to decision block 404, if the current storage usage does not exceed the upper usage threshold 204, the file system/storage driver 124 may determine (decision block 410) whether the current storage usage has fallen below the lower usage threshold 206. If the current storage usage is below the lower usage threshold 206, the flash controller 108 may decrease the amount of free space on the NAND flash 104 (block 412). The flash controller 108 may read a second portion of compressed data from the NAND flash 104. The second portion of compressed data may be uncompressed to generate a second portion of uncompressed data. The second portion of uncompressed data may be rewritten to the NAND flash 104. The timer (block 408) may be used to periodically check the storage usage and return flow to decision block 404.

FIG. 5 is a data diagram 500 illustrating exemplary blocks of compressed and uncompressed data in the NAND flash 104. Block 504 comprises uncompressed data 506. Block 502 shows an exemplary implementation for compressing data. After compression, the block 502 comprises compressed data 508 leaving free space 512. The compressed data 508 may include compression metadata (e.g., a compression flag checksum 510). When selecting blocks of data for compression or decompression, the selective compression/decompression component 134 may check for a predetermined compression flag in the header. If the flag does not present in the header position (block 506), the data is not stored in a compressed format, and this block may be indicated as a potential target for compression. If the flag presents in the header position, then the selective compression/decompression component 134 may further compute a checksum of the data in the block. If the computed checksum matches the checksum in the header, then the selective compression/decompression component 134 may determine that the data is stored in a compressed format, and that this block is a potential target for decompression.

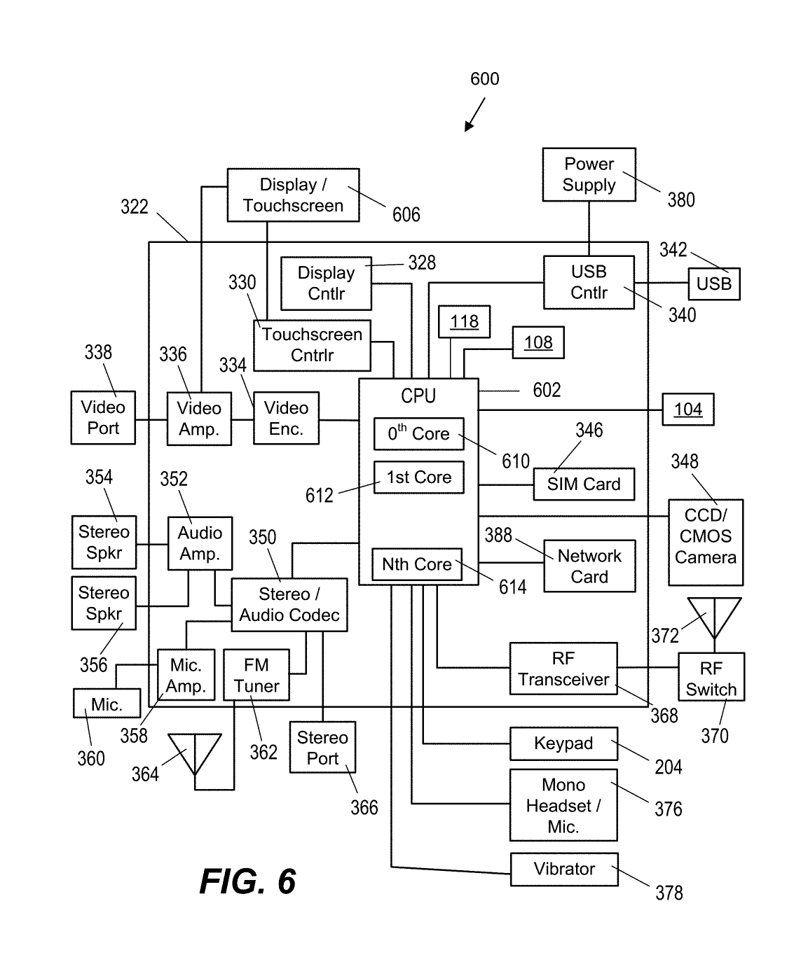

As mentioned above, the system 100 may be incorporated into any desirable computing system. FIG. 6 illustrates the system 100 incorporated in an exemplary portable computing device (PCD) 600. It will be readily appreciated that certain components of the system 100 may be included on the SoC 322 (e.g., data compression component 118 and flash controller 108) while other components (e.g., the DRAM 106, the NAND flash 104) may be external components coupled to the SoC 322. The SoC 322 may include a multicore CPU 602. The multicore CPU 602 may include a zeroth core 610, a first core 612, and an Nth core 614. One of the cores may comprise, for example, a graphics processing unit (GPU) with one or more of the others comprising the CPU.

A display controller 328 and a touch screen controller 330 may be coupled to the CPU 602. In turn, the touch screen display 606 external to the on-chip system 322 may be coupled to the display controller 328 and the touch screen controller 330.

FIG. 6 further shows that a video encoder 334, e.g., a phase alternating line (PAL) encoder, a sequential color a memoire (SECAM) encoder, or a national television system(s) committee (NTSC) encoder, is coupled to the multicore CPU 602. Further, a video amplifier 336 is coupled to the video encoder 334 and the touch screen display 606. Also, a video port 338 is coupled to the video amplifier 336. As shown in FIG. 6, a universal serial bus (USB) controller 340 is coupled to the multicore CPU 602. Also, a USB port 342 is coupled to the USB controller 340.

Further, as shown in FIG. 6, a digital camera 348 may be coupled to the multicore CPU 602. In an exemplary aspect, the digital camera 348 is a charge-coupled device (CCD) camera or a complementary metal-oxide semiconductor (CMOS) camera.

As further illustrated in FIG. 6, a stereo audio coder-decoder (CODEC) 350 may be coupled to the multicore CPU 602. Moreover, an audio amplifier 352 may coupled to the stereo audio CODEC 350. In an exemplary aspect, a first stereo speaker 354 and a second stereo speaker 356 are coupled to the audio amplifier 352. FIG. 6 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 6 further illustrates that a radio frequency (RF) transceiver 368 may be coupled to the multicore CPU 602. An RF switch 370 may be coupled to the RF transceiver 368 and an RF antenna 372. A keypad 204 may be coupled to the multicore CPU 602. Also, a mono headset with a microphone 376 may be coupled to the multicore CPU 602. Further, a vibrator device 378 may be coupled to the multicore CPU 602.

FIG. 6 also shows that a power supply 380 may be coupled to the on-chip system 322. In a particular aspect, the power supply 380 is a direct current (DC) power supply that provides power to the various components of the PCD 600 that require power. Further, in a particular aspect, the power supply is a rechargeable DC battery or a DC power supply that is derived from an alternating current (AC) to DC transformer that is connected to an AC power source.

FIG. 6 further indicates that the PCD 600 may also include a network card 388 that may be used to access a data network, e.g., a local area network, a personal area network, or any other network. The network card 388 may be a Bluetooth network card, a WiFi network card, a personal area network (PAN) card, a personal area network ultra-low-power technology (PeANUT) network card, a television/cable/satellite tuner, or any other network card well known in the art. Further, the network card 388 may be incorporated into a chip, i.e., the network card 388 may be a full solution in a chip, and may not be a separate network card 388.

As depicted in FIG. 6, the touch screen display 606, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 may be external to the on-chip system 322.

It should be appreciated that one or more of the method steps described herein may be stored in the memory as computer program instructions, such as the modules described above. These instructions may be executed by any suitable processor in combination or in concert with the corresponding module to perform the methods described herein.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example.

Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the Figures which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, NAND flash, NOR flash, M-RAM, P-RAM, R-RAM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Alternative embodiments will become apparent to one of ordinary skill in the art to which the invention pertains without departing from its spirit and scope. Therefore, although selected aspects have been illustrated and described in detail, it will be understood that various substitutions and alterations may be made therein without departing from the spirit and scope of the present invention, as defined by the following claims.

What is claimed is:

1. A method for selectively compressing/decompressing flash storage data, the method comprising:
defining a storage usage collar associated with a flash memory device, the storage usage collar comprising an upper usage threshold and a lower usage threshold;
if the storage usage exceeds the upper usage threshold of the storage usage collar, increasing an amount of free space on the flash memory device by: reading a first portion of uncompressed data from the flash memory device, compressing the first portion of uncompressed data to generate a first portion of compressed data, and rewriting the first portion of compressed data to the flash memory device; and
if the storage usage falls below the lower usage threshold of the storage usage collar, decreasing the amount of free space on the flash memory device by: reading a second portion of compressed data from the flash memory device, uncompressing the second portion of compressed data to generate a second portion of uncompressed data, and rewriting the second portion of uncompressed data to the flash memory device.

2. The method of claim 1, wherein the flash memory device comprises NAND flash.

3. The method of claim 1, wherein the compressing and the decompressing are implemented by a processor device in communication with a flash controller.

4. The method of claim 1, wherein the upper usage threshold and the lower usage threshold are adjusted.

5. The method of claim 1, wherein the storage usage is periodically compared to the storage usage collar.

6. The method of claim 1, wherein the first portion of uncompressed data and the second portion of compressed data read from the flash memory device are selected by inspecting a file system directory associated with the flash memory device.

7. The method of claim 6, wherein the inspecting the file system directory involves a background scrubbing process.

8. A system for selectively compressing/decompressing flash storage data, the system comprising:
means for defining a storage usage collar associated with a flash memory device, the storage usage collar comprising an upper usage threshold and a lower usage threshold;
means for increasing an amount of free space on the flash memory device if the storage usage exceeds the upper usage threshold of the storage usage collar by: reading a first portion of uncompressed data from the flash memory device, compressing the first portion of uncompressed data to generate a first portion of compressed data, and rewriting the first portion of compressed data to the flash memory device; and
means for decreasing the amount of free space on the flash memory device if the storage usage falls below the lower usage threshold of the storage usage collar by:
reading a second portion of compressed data from the flash memory device, uncompressing the second portion of compressed data to generate a second portion of uncompressed data, and rewriting the second portion of uncompressed data to the flash memory device.

9. The system of claim 8, wherein the flash memory device comprises NAND flash.

10. The system of claim 8, wherein the compressing and the decompressing are implemented by a processor device in communication with a flash controller.

11. The system of claim 8, wherein the upper usage threshold and the lower usage threshold are adjusted.

12. The system of claim 8, further comprising:
means for periodically comparing the storage usage to the storage usage collar.

13. The system of claim 8, further comprising:
means for inspecting a file system directory associated with the flash memory device to select the first portion of uncompressed data and the second portion of compressed data to be read from the flash memory device.

14. The system of claim 13, wherein the means for inspecting the file system directory comprises a background scrubbing process.

15. A computer program embodied in a memory and executable by a processor for selectively compressing/decompressing flash storage data, the computer program comprising logic configured to:
define a storage usage collar associated with a flash memory device, the storage usage collar comprising an upper usage threshold and a lower usage threshold;
if the storage usage exceeds the upper usage threshold of the storage usage collar, increase an amount of free space on the flash memory device by: reading a first portion of uncompressed data from the flash memory device, compressing the first portion of uncompressed data to generate a first portion of compressed data, and rewriting the first portion of compressed data to the flash memory device; and
if the storage usage falls below the lower usage threshold of the storage usage collar, decrease the amount of free space on the flash memory device by: reading a second portion of compressed data from the flash memory device, uncompressing the second portion of compressed data to generate a second portion of uncompressed data, and rewriting the second portion of uncompressed data to the flash memory device.

16. The computer program of claim 15, wherein the flash memory device comprises NAND flash.

17. The computer program of claim 15, wherein a processor device in communication with a storage driver executes the compressing and the decompressing.

18. The computer program of claim 15, wherein the upper usage threshold and the lower usage threshold are adjusted.

19. The computer program of claim 15, further comprising logic configured:
periodically compare the store usage to the storage usage collar.

20. The computer program of claim 15, further comprising logic configured to:
inspect a file system directory associated with the flash memory device to determine the first portion of uncompressed data and the second portion of compressed data to be read from the flash memory device.

21. The computer program of claim 20, wherein the logic configured to inspect the file system directory comprises a background scrubbing process.

22. A system for selectively compressing/decompressing flash storage data, the system comprising:
a compression/decompression component;
a flash memory device;
a flash controller in communication with the flash memory device; and
a storage driver in communication with the flash controller, the storage driver configured to selectively control compression and decompression of data stored in the flash memory device, via the compression/decompression component, according to a storage usage collar comprising an upper usage threshold and a lower usage threshold.

23. The system of claim 22, wherein the storage driver is further configured to:
increase an amount of free space on the flash memory device if the storage usage exceeds the upper usage threshold of the storage usage collar; and
decrease the amount of free space on the flash memory device if the storage usage falls below the lower usage threshold of the storage usage collar.

24. The system of claim 23, wherein the storage driver increases the amount of free space when the storage usage exceeds the upper usage threshold by:
reading a first portion of uncompressed data from the flash memory device, compressing the first portion of uncompressed data to generate a first portion of compressed data;
and rewriting the first portion of compressed data to the flash memory device.

25. The system of claim 24, wherein the storage driver decreases the amount of free space on the flash memory device if the storage usage falls below the lower usage threshold of the storage usage collar by:
reading a second portion of compressed data from the flash memory device;
uncompressing the second portion of compressed data to generate a second portion of uncompressed data; and
rewriting the second portion of uncompressed data to the flash memory device.

26. The system of claim 22, wherein the flash memory device comprises NAND flash.

27. The system of claim 22, wherein the upper usage threshold and the lower usage threshold are adjusted.

28. The system of claim 22, wherein the storage driver is further configured to periodically compare the store usage to the storage usage collar.

29. The system of claim 22, wherein the compression/decompression component and the flash controller reside on a system on chip (SoC) electrically coupled to the flash memory device.

30. The system of claim 29, incorporated in a portable computing device comprising one of a smart phone, a tablet computer, and a wearable device.
